(19) United States
(12) Patent Application Publication
(10) Pub. No.: US 2018/0006422 A1
(43) Pub. Date: Jan. 4, 2018

(54) Methods for Disrupting Hurricane Activity

(71) Applicant: R Joe Planson, Mountain Brook, AL (US)

(72) Inventor: R Joe Planson, Mountain Brook, AL (US)

(21) Appl. No.: 14/146,238

(22) Filed: Jan. 2, 2014

(51) Int. Cl. H01S 3/00; F41H 13/00; A01G 15/00

(52) U.S. Cl. CPC H01S 3/0007; F41H 13/005; A01G 15/00

(57) ABSTRACT

Intensity increases in hurricanes result from electrical and magnetic conditions from cloud rotation that establish the appropriate environment for electromagnetic induction (EMI) of conductive materials, to heat energy. The means of slowing down or redirecting a hurricane begins by first locating a hurricane or tropical depression. The path of said hurricane must be anticipated in order to effectively slow down, reduce intensity and steer the hurricane. By removing salt and other conductive materials from its path, a hurricane can be steered to cooler waters where the energy sources for said hurricane are not sufficient to sustain the storm. To maximize disruption of hurricanes steps should be taken as early in formation as possible to disrupt the electrical connection and accumulation of charged materials.

### FIELD OF INVENTION

The field of invention is methods for injury and damage prevention to people and property specifically by reducing intensity, dissipating, or redirecting a hurricane.

### BACKGROUND OF INVENTION

Due to their destructive nature, natural disasters have always been the subject of research and observation by man. Of all natural disasters, hurricanes may be the most powerful and destructive. Despite the many years of research, hurricanes are still not fully understood by scientists and, therefore, still cause significant damage that further research and understanding may be able to prevent.

While scientists can accurately predict and monitor these powerful storms, little outside of “storm proofing” homes and businesses or outright evacuation are means to protect individuals and property from hurricanes. The methods by which hurricanes increase and decrease intensity are not fully understood by scientists today and, as a result, mankind has been unable to tame these destructive storms. According to the past ten years of data collected by the National Ocean and Atmospheric Administration (NOAA), despite the effectiveness in monitoring and predicting hurricane paths, an average of 109 people are killed each year by hurricanes. Individual storms, such as Hurricane Katrina, can cause upwards of 1,000 fatalities and over $100 billion in property damage. After viewing these numbers, the need for improved understanding of hurricanes and a means to prevent damage and loss of life is evident.

Hurricanes are known around the world by different names such as tropical cyclones or typhoons and these names can be used interchangeably hereafter. Hurricane formation begins when warm, moist air rises from the surface of the ocean. This creates a low pressure region near the surface of the water that is the filled by cooler, high pressure air. This air is then warmed by the ocean and rises as well. The warm air carries water into the atmosphere with it and forms clouds. The constant flow of air causes rotation and the spiraling nature of the storm causes further exchange of warm and cold air. This leads to low pressure areas that provide the environment for hurricane formation. Once winds reach 39 mph a tropical storm is formed and when winds reach 74 mph, a tropical cyclone, or hurricane, is formed.

Loss of induction heat energy inputs, ionized gases, and cold air infusion result in death of the hurricane. Conductive materials that are heated, giving up their heat energy to the surroundings by conduction and convection due to fast air rotation, will maintain their conductivity and be electromagnetically induced until they are expelled by centrifugal forces from the funnel area. However, fallout loss of conductive materials by centrifugal forces with time may also reduce heating. When these electric charge fields begin rotating due to the vertical shear winds of a hurricane, a magnetic field is created. This electromagnetic field, thus, becomes a defining characteristic of hurricanes and, through induction, the mechanism which drives them. Electromagnetic induction (EMI) needs conductive fuel to drive the process. In the EMI process, charged materials are thermodynamically heated to convert electrical energy to heat energy to provide energy to the system. Irregular movement of the charged materials and increases in charged materials increase EMI heating.

When conductive ionized salt from sea water is picked up into the atmosphere by the storm and conductive ions in the air begin to rotate, a current is formed. Differences between charges in the air and water result in an electric field and when current rotates in an electric field, a magnetic field is also formed. This environment creates what is known as electromagnetic induction that fuels the hurricane by converting electrical energy to heat energy that feeds the system and intensifies the storm. This electromagnetic process uses conductive materials to heat the surrounding atmosphere and fuel the system. Lightning-produced ionized gases, salt in the ocean and hot towers are the sources of conductive materials for a hurricane so, removing or disrupting these sources is the means to controlling a hurricane.

This fuel is found in the form of conductive materials which can be defined as anything that carries an electrical charge that can drive the hurricane. When storms discharge electrical energy through lightning, the large amounts of energy released results in the breaking of chemical bonds holding atmospheric particles together, in turn, creating more available charged particles to fuel the hurricane. In effect, lightning strikes create more fuel to feed the electromagnetic process that contributes to storm intensity increases of a hurricane. This is seen in NO_{X} conversion and ozone reactions leading to the ionization of highly conductive nitrogen (N) and oxygen (O) ions that make up the majority of atmospheric gases. Consumption of ionized gases (chemical conversion from ionized to non-ionized) takes away inducible food in the immediate storm system and with little to no conductive material input and lower lightning levels from electromagnetic induction conversion areas, the hurricane energy levels fade. Gravity waves can also have a great influence on hurricane intensification as they distort magnetic fields, increase wind speeds and cause irregular movement of electrons in a variable magnetic field that induces and converts electrical energy to heat energy. Increasing the conductivity of the system allows electricity to flow more freely. Electrical energy is then thermodynamically converted to heat energy and heat transferred by fast moving winds in a hurricane.

Scientists believe that warm environments are the fuel for hurricanes. While hurricanes do seek warmer water, it is because conductive materials are more readily available in warmer waters and atmospheres due to the higher energy level of the surroundings. Lightning is an excellent source of conductive materials because it ionizes atmospheric gases and occurs frequently in hurricanes. When the warm ocean water rises in the storm, it leaves ionized salt particles in the atmosphere to also feed the hurricane system. In addition, hot towers are essentially mini cyclones that feed conductive materials back into the hurricane. By removing available conductive materials, hurricanes can be weakened and removing materials in strategic locations can help steer hurricanes away from populated land and send them towards the colder waters such as the North Atlantic to die down without causing damage.

Past inventions have focused on using super-cooled substances such as liquid nitrogen to reduce heat available for the hurricane, chemicals such as silver iodide to flash freeze water in clouds and dispersing cold water into the ocean to remove heat energy. Another method that has been discussed is running pipes deep into the ocean with valves on the end. Waves would open and shut the valve and force cold water up the pipe and onto the ocean surface to reduce heat energy needed to fuel the storm. While these inventions do work to remove available energy from the system, they fail to focus on the greatest source of energy-conductive materials in the atmosphere. However, adding conductive materials to the storm at the wrong time may increase intensity.

These past inventions have either yielded inconclusive results or need further research to determine the usefulness of the method. The statistics discussed earlier show that there is a great need to find ways to divert and calm hurricanes in an effort to save lives and property. Moving forward, any future inventions must be ready to deploy at short notice, cost effective, safe to individual and leave no residual damage to the environment.

### SUMMARY OF PRESENT INVENTION

The present invention is defined by the claims to follow and nothing in this section should be understood as a limitation to said claims.

The invention describes methods to reduce conductive materials in the areas surrounding hurricanes or areas of potential hurricane activity to disrupt hurricane activity, reduce intensity and/or control the path of hurricanes by forcing them away from landfall and into deeper and/or colder waters. The first step is to locate an area of hurricane or possible hurricane activity and determine the path that said activity will take. Intervention early in the lifecycle of the storm is ideal because it requires fewer resources and improves the chances of success. Once a path is predicted and/or determined, the first method to disrupting hurricane activity is to reduce the conductive materials available by removing salt ions picked up by the storm or from the ocean water. This can be done though an up scaled version of the “water chip,” which uses electrical diodes to attract chloride ions. This allows clean water to pass through without the electrically charged ions from salt. These devices will either be deployed by plane, drone, submarine or ship, or dropped into the ocean ahead of time in strategic locations to combat hurricanes.

The second method uses a chemical agent to remove charged particles from the atmosphere; thereby, reducing conductive materials available to the hurricane. This chemical agent would either be dispersed directly from the plane or released from a container carried by said plane or other release vehicle. The chemical agent binds to negatively charged ions to remove atmospheric charges and conductive materials from areas surrounding the hurricane. Molecules then drift away and leave no residual environmental damage to the surrounding area.

The third method involves discharging lasers in the area ahead of the hurricane to ionize the gases and allow them to convert to a deionized state by NO_{X} conversion; thus, reducing the conductive gases in the air ahead of the storm and reducing EMI heating input to the storm. This reduces the available conductive materials needed to sustain the hurricane. The preferred laser should emit ultraviolet (UV) laser pulses. Lasers should be discharged at least thirty minutes ahead of, and not into, the storm to allow atmospheric gases to deionize and reach ground state.

In preferred embodiments of the laser discharge method, lasers can be mounted to buoys placed in strategic location—possibly in a grid pattern—based on historic data of areas of high hurricane activity, on planes, or remotely operated drones, or satellites orbiting the earth.

### DETAILED DESCRIPTION OF HOW IT WILL BE USED

The invention describes and claims methods for disrupting hurricane activity by slowing down and/or steering the hurricane away from landfall. The goal is to prevent storm formation or intensity increases by causing an electrical disconnect in the electrical helical coil. This will either prevent hurricane formation or reduce the storm intensity by disrupting the electrical current flow. The first step is to locate an area of hurricane activity and subsequently determine the anticipated path of said hurricane. Once a path is determined the first method is to desalinate the surrounding atmosphere and/or ocean water to reduce the availability of conductive materials to the hurricane. As hurricanes in the Gulf of Mexico approach the Mississippi River, they tend to weaken due to the influx of fresh water from the river that reduces the conductive materials available for the storm. This provides evidence to the theory that fresh water dilutes the conductive material content in the storm system, thereby, reducing storm intensity.

In the first method of this invention, an improved and upscaled version of the “water chip” invented by researchers at the University of Texas is used to remove salt from the ocean in the path of the hurricane; thereby, reducing the conductive material source for the hurricane to sustain itself. Placing these chips in the path of the hurricane will create a salt gradient in the ocean and will either weaken the hurricane or cause it to reroute in an effort to find the path of least resistance (more conductive energy sources). By doing so we can effectively steer the hurricane out to deeper waters and away from landfall while, at the same time, weakening the storm. This may also be combined with a method to add salt or other conductive materials to areas around the storm that would help steer it away from landfall or dictate the path.

To desalinate the water, a small electrical charge is applied to a plastic chip filled with saltwater. When the charge is applied, chloride ions are attracted to one of two branches in a microchannel that contains an electrode. This electrode creates an “ion depletion zone” that increases the local charge in comparison to the rest of the channel. The charge field attracts and stores salt to that branch, allowing clean water to flow through the other.

In preferred embodiments of this method, “water chips” would be either dropped from airplane, drone, submarine or deployed from ships into the path of hurricanes with enough lead time to desalinate the ocean water. The “water chips” would then be activated to begin processing salt out of the water. Additional “water chips” can be deployed further down the anticipated path to continue steering the hurricane away from land until it dies out in the ocean. These additional units can be deployed in advance of the storm and remotely activated at the appropriate time to maximize the reduction of salt.

Another embodiment of the “water chip” method is to place these desalination devices in strategic locations, for example, in the Atlantic Ocean that follow the United States coast northward to help divert hurricanes. In other parts of the earth devices would also be placed in areas that are prone to hurricane or typhoon activity. These devices can be free floating or attached to buoys and remotely activated when necessary to help push oncoming hurricanes away from the coast and back into deeper waters.

The second method of this invention is to use a chemical dispersed into the atmosphere that would remove charged particles from the atmosphere; thereby, reducing the conductive material source for the hurricane. The chemical would ideally be released ahead of the hurricane by a remotely operated plane (drone). This would reduce the risk of injury to pilots and crew that would be tasked with flying the airplane near a storm. In the preferred embodiment of the present method, polonium 210 would be used to remove charged materials from the atmosphere.

Polonium 210 is a radioactive element found in small quantities in the environment. It can also be synthesized in a laboratory environment. Today, polonium 210 is used to remove static electricity in machinery and to provide “clean rooms” by neutralizing charges in the surrounding atmosphere. It is hazardous to humans only when taken into the body but is subject to no IAEA safeguards. Therefore, for the purposes of this method, polonium 210 is safe to humans and the environment.

Polonium 210 is an alpha-emitter that collides with air molecules. Each time alpha particles strike an air molecule they ionize said molecule and lose energy with each collision. Each alpha particle only travels a few centimeters before it stops; however, it can create hundreds of thousands of ion pairs along its path. The alpha particle then picks up two electrons to form a helium atom and drifts away into the atmosphere. This process removes charged particles from the surrounding atmosphere, effectively neutralizing any charge in the surrounding area. This is ideal for stopping hurricanes by removing the conductive material energy source needed to fuel the storm. Because the alpha particles only travel a few centimeters, they are of no health concern to any individuals in the region of dispersal and the end result is helium atoms that yield no toxic effects on the environment.

In the first embodiment of the polonium 210 dispersion method, the chemical would be contained in either one or multiple containers on board the drone or attached externally to the plane. The chemical is either dispersed into the atmosphere or dropped from the canisters to be released into the atmosphere at a designated time and altitude. For example, the chemical may be released from containers in the same fashion that a farmer releases chemicals on his fields via a crop duster airplane. In this embodiment, the chemical would be released ahead of the storm by either a single, or multiple, plane(s) or drone(s) at the appropriate altitude to maximize the removal of charged particles available to fuel the storm.

In the second embodiment, the chemical would be released in containers from the drone, plane or other delivery method at the appropriate time ahead of the hurricane. Containers could be affixed with an altimeter or remotely detonated to trigger release of the chemical at the designated height. Alternatively, containers may be shaped and formed in the fashion of present bomb designs and may, in fact, be chemical bombs of existing design. Containers may also be smart bombs or missiles that can be guided to be detonated at remote locations. Desirable altitudes for the release of the chemical would be near cloud formations. This is the area of highest charged particle concentration, so chemical dispersion would be the most effective.

The third method involves discharging lasers ahead of the hurricane. The term laser refers to a focused beam of light that can travel long distances without decreased collimation. In the present method, a specific laser is used based on past research by Khan et. al. 2002 that suggests ultraviolet laser pulses are ideal for laser-induced lightning discharge. According to the research,
UV (220-420 nm) 200 ps laser pulses with a peak power of around 50 MW (or 12.5) mJ input energy) and a beam size of 100 μm are the optimal tool to trigger outdoor lightning. The laser beam size remains relatively small (less than 0.3 mm) after a propagation distance of 200 m up into the normally cloudy and damp atmospheric conditions.

In preferred embodiments of the current method, lasers are discharged in areas of likely, or ongoing, hurricane activity at least thirty minutes ahead of the hurricane to prevent or disrupt hurricane activity; in effect stealing away the conductive gases needed to cause induction. Lasers can potentially be discharged by laser mounted buoys, planes or remotely operated drones, submarines, satellite or other device capable of mounting a laser.

The lasers will be discharged in the predicted path of the storm to remove conductive materials and ahead of the storm and, in effect, disable the eye. The laser must be discharged far enough ahead of the storm for the resulting lightning to ionize the air and for atmospheric gases to return to a ground (non-ionized) state. If there is not enough lead time for deionization to occur then laser discharges only feed the hurricane. However, if laser discharges occur too far ahead of the hurricane, there will be time for the air to deionize and again ionize before the hurricane arrives. Ionized atmospheric gases have a half-life of approximately 30 minutes. Therefore, lasers would trigger lightning approximately forty five minutes ahead of the storm to give atmospheric gases time to deionize but not enough time to again ionize ahead of the hurricane.

The particular embodiments described above are strictly illustrative and should in no way be considered as restrictive upon the invention. It is to be understood also that modifications and changes to the invention may be devised by those skilled in the field of the invention and fall within the scope thereof. It is not desired to limit the invention to the above constraints. The invention is defined by the following claims and all variations that fall within the claims are intended to be accepted therein.

I claim:

1. A method of disrupting hurricane activity by preventing or reducing an electrical connection of the electrical helical coil of an impending storm (of any type including a hurricane) or creating an electrical disconnect in an existing storm through any available means, wherein altering, controlling or manipulating lightning activity in or around the storm achieves said electrical disconnect or any portion thereof.

2. A method of disrupting hurricane activity by preventing or reducing an electrical connection of the electrical helical coil of an impending storm (of any type including a hurricane) or creating an electrical disconnect in an existing storm through any available means, wherein magnetic fields characteristic of the storm are altered, controlled or manipulated.

3. A method of disrupting hurricane activity by preventing an electrical connection of the electrical helical coil of an impending storm or creating an electrical disconnect in an existing storm through any available means, wherein rotation is maintained by electromagnetic induction and the consumption of conductive materials in the area surrounding the hurricane, both in the air and in the ocean, comprising the steps of:
a. Locating an area conducive to or containing hurricane; wherein the area contains the appropriate conditions for the formation of a tropical storm and/or a hurricane,
b. Releasing a chemical agent into the area ahead of the storm and/or hurricane,
c. Wherein the chemical agent is released at the altitude of cloud formation ahead of the storm,
d. And wherein the chemical agent is contained in a container and is released from the container by dispersion into the atmosphere by hose, pipe or other method,
e. And wherein the chemical agent is delivered to the area ahead of the storm and/or hurricane by remotely piloted airplane; drone; or other dispersion vehicle (ex. Rocket, submarines, etc.),
Wherein the area of possible or ongoing hurricane activity is comprising of:
a storm that contains the appropriate level of environmental conditions for hurricane formation,
wherein releasing a chemical agent into the area ahead of the storm and/or hurricane,
wherein the chemical agent is released at the altitude of cloud formation ahead of the storm,
f. And wherein the chemical agent is contained in a container and the container is released from the drone or other dispersion vehicle to be detonated remotely ahead of the hurricane.

4. A method of disrupting hurricane activity by preventing an electrical connection of the electrical helical coil of an impending storm or creating an electrical disconnect in an existing storm through any available means, wherein rotation is maintained by electromagnetic induction and the consumption of conductive materials in the area surrounding the hurricane, both in the air and in the ocean, comprising the steps of:
a. Locating an area conducive to or containing a hurricane; wherein the area contains the appropriate conditions for the formation of a tropical storm and/or a hurricane,
b. Deploying devices that contain desalination technology to remove salt from areas surrounding the hurricane or possible areas of hurricane activity
c. Wherein the desalination technology removes salt from the ocean to effectively “steer” the hurricane or tropical storm away from landfall
d. Wherein the devices are released in advance of the storm to provide appropriate time to effectively desalinate saltwater in the anticipated storm path,
e. And wherein the device is dropped from a remotely piloted plane, drone, or other dispersion vehicle (ex. Rocket, submarine, etc.) in strategic locations,
f. Wherein the device is capable of flotation to remain on the surface of the water,
g. Release fresh water into the area around the storm to dilute electrical conductivity of salt water,
h. Add salt or other conductive materials in the desired storm path to increase electrical conductivity to direct the storm away from populated areas and into colder waters where it can die down without causing damage,
i. Combine methods to increase conductivity in the desired path of the storm and reduce conductivity in the undesired path.
Wherein the area of possible or ongoing hurricane activity is comprising of:
A storm that contains the appropriate level of environmental conditions for hurricane formation,
Wherein deploying devices that contain desalination technology to remove salt from areas surrounding the hurricane or possible areas of hurricane activity, including air and sea
Wherein the device is capable of flotation to remain on the surface of the water
j. Wherein said devices are placed in strategic locations around the world.
k. Wherein said devices are temporary or permanently located in areas historically know to be paths of hurricanes
l. Wherein said devices can be remotely activated to desalinate water when the need arises to “steer” a hurricane.

5. A method of disrupting hurricane activity by preventing an electrical connection of the electrical helical coil of an impending storm or creating an electrical disconnect in an existing storm through any available means, where rotation is maintained by electromagnetic forces and the consumption of conductive materials (i.e. charged particles) in the area surrounding the hurricane at different altitudes, comprising the steps of:
a. Locating an area conducive to or containing a hurricane; wherein the area contains the appropriate conditions for the formation of a tropical storm and/or a hurricane,
b. Discharging lasers in the area ahead of potential or ongoing hurricane activity,
c. Wherein the laser is discharged at least thirty (30) minutes ahead of the storm or hurricane to ionize atmospheric gases; giving them time to deionize by natural chemical reactions,
d. Wherein discharging of the laser produces lightning strikes ahead of the storm which result in a loss of available conductive materials for hurricane formation and/or continuation,
e. Wherein the laser discharged ahead of the storm is located in fixed positions mounted to buoys on the ocean surface,
f. Wherein the locations for buoy are based on areas of historically high hurricane activity,
Wherein the area of possible or ongoing hurricane activity is comprising of:
A storm that contains the appropriate level of environmental conditions for hurricane formation,
Wherein the laser is discharged at least thirty (30) minutes ahead of the storm and/or hurricane,
Wherein discharging the laser produces lightning strikes ahead of the storm which result in a loss of available conductive materials for hurricane formation and/or continuation,
g. Wherein the laser discharged ahead of the storm is mounted to a plane or remotely operated airplane, drone, submarine, or other delivery vehicle to be detonated ahead of the storm,
Wherein the laser is discharged at least thirty (30) minutes ahead of the storm or hurricane,
Wherein discharging the laser produces lightning strikes ahead of the storm which result in a loss of available conductive materials for hurricane formation and/or continuation,
h. Wherein the laser discharged ahead of the storm is fired from a satellite in orbit of the earth.

6. A_method of disrupting hurricane activity by preventing an electrical connection of the electrical helical coil of an impending storm or creating an electrical disconnect in an electromagnetic induction and the consumption of conductive materials in the area surrounding the hurricane, both in the air and in the ocean, comprising the steps of:
a. Locating an area conducive to or containing a hurricane; wherein the area contains the appropriate conditions for the formation of a tropical storm and/or a hurricane,
b. Dispersing salt or other conductive materials in the area surrounding hurricane activity,
Wherein the salt or other conductive materials steer the storm out of the current path and into a more desirable direction (i.e. away from landfall and towards colder waters),
c. Wherein the salt or conductive materials are released into the atmosphere or ocean water by any available vehicle or dispersion method.

7. The method of combining claims 1, 2 and 3 to disrupt hurricane activity.
